(19) United States
(12) Patent Application Publication
(10) Pub. No.: US 2020/0194959 A1
(43) Pub. Date: Jun. 18, 2020

(54) Generation of Ultrashort Laser Pulses at Wavelengths

(71) Applicant: TOPTICA Photonics AG, Grafelfing (DE)

(72) Inventors: Axel Friedenauer, Hohenschaftlarn (DE); Robert Herda, Munchen (DE)

(73) Assignee: TOPTICA Photonics AG, Grafelfing (DE)

(21) Appl. No.: 16/223,844

(22) Filed: Dec. 18, 2018

(51) Int. Cl. H01S 3/109; H01S 3/067; H01S 3/11; H01S 3/094; H01S 3/16; H01S 3/102; H01S 3/13

(52) U.S. Cl. CPC H01S 3/109; H01S 3/06708; H01S 3/1106; H01S 3/1301; H01S 3/1616; H01S 3/1608; H01S 3/1024; H01S 3/094007

(57) ABSTRACT

A method for generating pulsed laser radiation in the spectral range from 860 nm to 1000 nm is disclosed, including the steps of generating pulsed laser radiation in the spectral range from 1500 nm to 1600 nm, preferably at a wavelength of 1560 nm; shifting the wavelength of the pulsed laser radiation to a longer wavelength of at least 1720 nm, and preferably to 1840 nm; amplifying the wavelength-shifted pulsed laser radiation in a Thulium-doped gain medium so that the Thulium-doped gain medium is pumped in an in-band pumping scheme; and frequency-doubling the amplified wavelength-shifted pulsed laser radiation. A laser system suitable for practicing the method is also disclosed.

### FIELD

The invention relates to a method for generating pulsed laser radiation in the spectral range, and in a particular though non-limiting example to a laser system for generating pulsed laser radiation in a spectral range of between 860 nm and 1000 nm.

### BACKGROUND

The interest in reliable laser sources of pulsed laser radiation at wavelengths around 900 nm is continuously increasing. For example, in the field of biomedical research, the imaging of living cells and tissues using laser-scanning microscopy is offering insights into the spatial and temporal controls of biological processes. The availability of genetically encoded labels such as green fluorescent protein (GFP) offers the possibility to trace cell movements, cell signaling or gene expression dynamically. Two-photon laser scanning microscopy (TPLSM) is ideally suited for imaging cells in vivo due to its deep tissue penetration. The optimal excitation wavelengths in these types of experiments are in the range from 890 nm to 950 nm. It is known in the art to generate the required laser radiation in a titanium sapphire mode-locked laser system. Such laser systems are able to produce laser radiation at, e.g., 900 nm, with a pulse duration of 200 fs and a repetition rate of about 80 MHz. These conventionally used laser systems have drawbacks however; for example, fiber laser systems are generally preferred due to their compactness and reliability. However, heretofore it has proven impossible, to provide a source of laser pulses in the mentioned wavelength range with a pulse duration on the order of 100 fs and an average power of more than 1 W, as presently demanded in certain technical disciplines, and in particular in biophotonics.

### SUMMARY

From the foregoing it is readily appreciated that there is a need for a method of generating pulsed laser radiation at 860-1000 nm with a pulse duration on the order of 100 fs and an average power of 1 W or more.

In accordance with the invention, a method for generating pulsed laser radiation in the spectral range from 860 nm to 1000 nm is disclosed. The method comprises the steps of:
generating pulsed laser radiation in the spectral range from 1500 nm to 1600 nm, preferably at a wavelength of 1560 nm;
shifting the wavelength of the pulsed laser radiation to a longer wavelength of at least 1720 nm, preferably to a wavelength of 1840 nm, e.g. through the Raman effect;
amplification of the wavelength-shifted pulsed laser radiation in a Thulium-doped gain medium, wherein the Thulium-doped gain medium is optically pumped in an in-band pumping scheme; and
frequency-doubling of the amplified wavelength-shifted pulsed laser radiation.

According to the invention, the initial pulsed laser radiation at 1500-1600 nm, preferably 1560 nm, may be generated by means of a conventional and commercially available diode-pumped mode-locked Erbium fiber laser with a pulse duration of less than 1 ps, preferably 400 fs to 800 fs, and a repetition rate of 10-100 MHz.

This initial laser radiation will typically require amplification, e.g. by means of a conventional Erbium-doped fiber amplifier, to an average power of 25 mW or more.

The amplified laser radiation is then wavelength-shifted to the range of 1720-2000 nm, preferably to 1840 nm (through Raman soliton shift or soliton self-frequency shift). This can be achieved, e.g., by propagating the amplified laser pulses through a section of about 10 m of passive PM1550 fiber. The central wavelength of the wavelength-shifted laser pulses can be tuned by variation of the average power of the laser radiation, e.g. by tuning the pump power of the Erbium-doped fiber amplifier.

Optionally, the spectral bandwidth of the laser radiation may be increased, if required, in a further step, e.g. through self-phase-modulation by propagating the laser radiation through a section of non-linear optical fiber. In particular, the pulsed laser radiation may be spectrally broadened by self-phase-modulation after the step of shifting the wavelength such that the spectral bandwidth of the wavelength-shifted pulsed laser radiation is more than 60 nm, preferably more than 100 nm. In this way, the desired pulse duration on the order of 100 fs can be achieved.

The wavelength-shifted (and optionally spectrally broadened) laser radiation is then amplified in order to obtain sufficient power for finally frequency-doubling the radiation into the desired spectral range from 860 nm to 1000 nm. Therein, the shortcomings of the prior art are overcome according to the invention by selecting a gain medium that is atypical for the wavelengths and by setting up an in-band pumping scheme of the gain medium with subsequent frequency doubling. The gain medium used is thulium (Tm), which is conventionally known and used for amplification in the wavelength range from 1950 nm to 2050 nm. However, the invention exploits the fact that the emission maximum of the Tm gain medium can be shifted into the 1840 nm range by an in-band pumping scheme. In the in-band pumping scheme, the Tm atoms in the ground state manifold of electronic energy levels are pumped directly to the manifold of energy levels which includes the laser level used for amplification, instead of pumping to an intermediate energy level (as in the case of standard pumping schemes). Due to the enormous achievable gain bandwidth of more than 100 nm, Tm also enables the generation of very short laser pulses of less than 100 fs.

The Tm gain medium can be pumped directly by an Erbium-Ytterbium fiber laser, which can be realized with common components and can be pumped by commercially available multimode pump diodes.

The frequency doubling of the wavelength-shifted and amplified short pulses at, e.g., 1840 nm preferably takes place in a suitable periodically poled or bulk crystal, depending on the power level.

The invention enables the generation of ultrashort laser pulses with a pulse duration of less than 100 fs at an average power of 1 W or more at a central wavelength of, e.g., 920 nm.

In a preferred embodiment of the invention, a chirped pulse amplification (CPA) scheme is employed. The optical peak intensities that occur in the Tm gain medium can become very high, so that detrimental nonlinear pulse distortion or even destruction of the gain medium or of some other optical element may occur. This can be effectively prevented by CPA. Before passing the laser radiation through the Tm-doped gain medium, the pulses are chirped and thereby temporally stretched to a much longer pulse duration of 10 ps or more, preferably at least 100 ps, by means of a strongly dispersive element (a stretcher, e.g. a fiber grating). This reduces the peak power in the gain medium to a level where the above-mentioned detrimental effects are avoided. After the Tm-doped gain medium, a dispersive compressor is used, i.e., an element with opposite dispersion (e.g. a grating pair or a prism arrangement), which removes the chirp and temporally compresses the pulses to a duration of less than 1 ps, preferably less than 100 fs.

In a further preferred embodiment of the invention, the Tm-doped gain medium is a single-clad optical fiber doped with Tm ions. The doped fiber is core-pumped by the pump laser. As mentioned before, the pump laser may be an Erbium/Ytterbium fiber laser, emitting at 1550-1610 nm with an average pump power of at least 500 mW. It is a further insight of the invention that the combination of core-pumping with the in-band pumping scheme results in the emission maximum of the Tm gain medium being effectively shifted into the required wavelength range and in a sufficient gain bandwidth.

The invention not only relates to a method but also to a laser system for generating pulsed laser radiation in the spectral range from 860 nm to 1000 nm. According to the invention, the laser system comprises:
a seed laser generating pulsed laser radiation in the spectral range from 1500 nm to 1600 nm, preferably at a wavelength of 1560 nm;
an optical fiber section shifting the wavelength of the pulsed laser radiation to a longer wavelength of at least 1720 nm, preferably to a wavelength of 1840 nm, e.g. through the Raman effect;
an optical amplifier comprising an Thulium-doped gain medium which amplifies the wavelength-shifted pulsed laser radiation;
a pump laser optically pumping the Thulium-doped gain medium in an in-band pumping scheme; and
a frequency-multiplier converting the wavelength of the amplified wavelength-shifted pulsed laser radiation to the spectral range from 900 nm to 950 nm.

### BRIEF DESCRIPTION OF THE DRAWINGS

FIG. 1 shows a system a laser system according to the invention as a block diagram.

### DETAILED DESCRIPTION OF SEVERAL EXAMPLE EMBODIMENTS

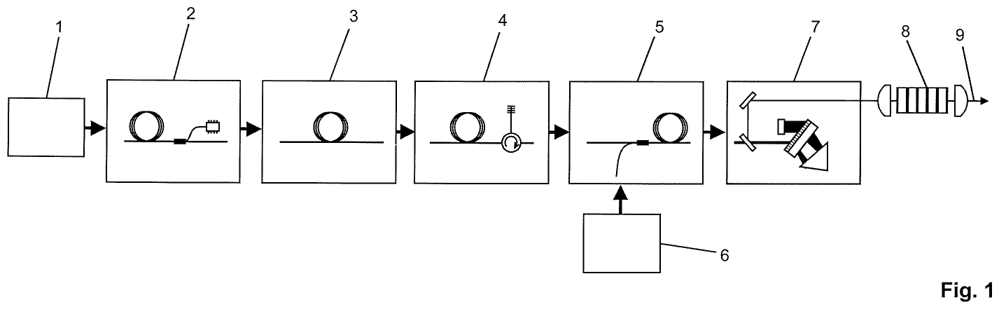

FIG. 1 schematically shows an embodiment of a laser system according to the invention as a block diagram.

The laser system comprises an Erbium-doped fiber laser oscillator 1 as a seed laser which emits a stable output pulse train at a fixed repetition rate of, e.g., 80 MHz. The seed laser 1 generates soliton pulses of a duration of 500 fs centered at a wavelength of 1560 nm. Mode-locking is achieved by a semiconductor saturable absorber mirror (not depicted).

A consecutive Erbium-doped fiber amplifier 2 receives the laser pulses from the seed laser 1 and boosts their energy such that the average power of the amplified pulse train is on the order of 100 mW.

The amplified pulses are wavelength-shifted through the Raman-Effect in a Raman unit 3 to a wavelength of 1840 nm in several meters of PM1550 fiber. The central wavelength of the wavelength-shifted seed pulses is tunable by the pump power of the boosting amplifier 2.

The wavelength-shifted laser pulses are then spectrally broadened in a SPM unit 4 such that the spectral bandwidth of the wavelength-shifted pulsed laser radiation is more than 60 nm, preferably more than 100 nm. The spectral broadening takes place self-phase-modulation (SPM) in a section of optical fiber having normal dispersion. The SPM unit 4 further comprises a dispersive fiber grating as a stretcher for stretching the laser pulses to a pulse duration of about 100 ps.

The stretched laser pulses are then amplified in a Thulium-doped fiber amplifier 5. The single-clad active fiber of the Thulium-doped fiber amplifier 4 is core-pumped by a 5 W pump laser 6 (Erbium/Ytterbium fiber laser) at 1570 nm in an in-band pumping scheme. The average power of the amplified laser pulses at 1840 nm at the output of the Thulium-doped fiber amplifier is 2-5 W.

The laser pulses are then re-compressed in a pulse compressor 7 comprising a dispersive grating and a prism to a pulse duration of less than 100-110 fs.

Finally, the compressed laser pulses are frequency-doubled in a periodically poled lithium niobate crystal 8. The laser pulses at the output 9 of the depicted laser system have an average power of more than 1 W at a wavelength of 920 nm with a pulse duration of 80-100 fs.

The foregoing specification is provided for illustrative purposes only, and is not intended to describe all possible aspects of the present invention. Moreover, while the invention has been shown and described in detail with respect to several exemplary embodiments, those of skill in the pertinent arts will appreciate that minor changes to the description and various other modifications, omissions and additions may be made without departing from the scope thereof.

1. A method for generating pulsed laser radiation in the spectral range from 860 nm to 1000 nm, the method comprising the steps of:
generating pulsed laser radiation in the spectral range from 1500 nm to 1600 nm, preferably at a wavelength of 1560 nm;
shifting the wavelength of the pulsed laser radiation to a longer wavelength of at least 1720 nm;
amplifying the wavelength-shifted pulsed laser radiation in a Thulium-doped gain medium, so that the Thulium-doped gain medium is pumped in an in-band pumping scheme; and
frequency-doubling the amplified wavelength-shifted pulsed laser radiation.

2. The method of claim 1, wherein the pulsed laser radiation is generated in the spectral range from 1500 nm to 1600 nm by a mode-locked Erbium fiber laser with a pulse duration of less than 1 ps.

3. The method of claim 1, wherein the pulsed laser radiation is amplified and spectrally broadened prior to shifting the wavelength.

4. The method of claim 1, wherein the pulsed laser radiation is spectrally broadened by self-phase-modulation after the step of shifting the wavelength such that the spectral bandwidth of the wavelength-shifted pulsed laser radiation is more than 60 nm.

5. The method of claim 1, wherein the wavelength-shifted laser pulses are stretched to a pulse duration of at least 10 ps prior to amplification in the Thulium-doped gain medium.

6. The method of claim 4, wherein the wavelength-shifted laser pulses are compressed to a pulse duration of less than 1 ps after amplification in the Thulium-doped gain medium.

7. The method of claim 1, wherein the Thulium-doped gain medium is a single-clad optical fiber.

8. The method of claim 7, wherein the single-clad optical fiber is core-pumped by a pump laser.

9. The method of claim 8, wherein the pump laser is an Erbium/Ytterbium fiber laser emitting at an average pump power of at least 500 mW.

10. A laser system for generating pulsed laser radiation in the spectral range from 860 nm to 1000 nm, comprising:
a seed laser (1) for generating pulsed laser radiation in the spectral range from 1500 nm to 1600 nm;
an optical fiber section shifting the wavelength of the pulsed laser radiation to a longer wavelength of at least 1720 nm;
an optical amplifier (4) comprising an Thulium-doped gain medium which amplifies the wavelength-shifted pulsed laser radiation;
a pump laser (5) for pumping the Thulium-doped gain medium in an in-band pumping scheme; and
a frequency-multiplier (7) converting the wavelength of the amplified wavelength-shifted pulsed laser radiation to the spectral range from 900 nm to 950 nm.

11. The laser system of claim 10, wherein the seed laser (1) is a mode-locked erbium fiber laser generating the pulsed laser radiation in the spectral range from 1500 nm to 1600 nm by a mode-locked Erbium fiber laser with a pulse duration of less than 1 ps.

12. The laser system of claim 10, further comprising an optical boosting amplifier (2), which receives the pulsed laser radiation from the seed laser (1) and boosts the average power of the pulsed laser radiation to more than 25 mW.

13. The laser system of any one of claim 10, further comprising a pulse stretcher stretching the wavelength-shifted laser pulses to a pulse duration of at least 10 ps prior to amplification in the Thulium-doped gain medium.

14. The laser system of claim 13, further comprising a pulse compressor (6) compressing the wavelength-shifted laser pulses to a pulse duration of less than 1 ps after amplification in the Thulium-doped gain medium.

15. The laser system of any one of claim 10, comprising a further optical fiber section spectrally broadening the wavelength-shifted pulsed laser radiation to a spectral bandwidth of at least 60 nm through self-phase-modulation.

16. The laser system claim 10, wherein the Thulium-doped gain medium is a single-clad optical fiber.

17. The laser system of claim 10, further comprising an Erbium/Ytterbium fiber laser as the pump laser (5) which core-pumps the single-clad optical fiber at an average pump power of at least 500 mW.

18. The laser system of claim 10, wherein the frequency-multiplier (7) is a periodically poled lithium niobate crystal.
